(19) United States
(12) Patent Application Publication
(10) Pub. No.: US 2013/0290067 A1
(43) Pub. Date: Oct. 31, 2013

(54) METHOD AND SYSTEM FOR ASSESSING RISK

(71) Applicant: Phillip Barton, Newark, CA (US)

(72) Inventor: Phillip Barton, Newark, CA (US)

(73) Assignee: IMERJ LLC, Broomfield, CO (US)

(21) Appl. No.: 13/455,948

(22) Filed: Apr. 25, 2012

(51) Int. Cl. G06Q 10/06

(52) U.S. Cl. 705/7.28

(57) ABSTRACT

The present disclosure relates to a risk module that determines an important set of a plurality of potential risk events for an organization, each member of the important set of potential risk events having no more than a selected probability of occurring but at least a selected significance of impact on the organization, whether a mitigation strategy exists for each member of the important set of the plurality of potential risk events, when a mitigation strategy exists for a selected member of the important set, determining a corresponding mitigated significance of impact for the selected member of the important set of the plurality of potential risk events, and a more important set of the plurality of potential risk events.

### FIELD

The disclosure relates generally to managing business risk and particularly to identifying, assessing, and controlling risk by an enterprise.

### BACKGROUND

Today's organizations are concerned not only about governance, control, and assurance (consulting) but also risk management. A common framework for risk management is Enterprise Risk Management (“ERM”). ERM is a process, which is effected by an organization's management (e.g., board of directors and other management) and other personnel, applied in a strategy setting and across the enterprise, designed to identify potential events that may impact the entity, manage risks to be within the enterprise's risk appetite, and provide a reasonable assurance regarding the achievement of entity objectives. COSO Enterprise Risk Management—Integrated Framework, 2004, COSO. ERM is important because every organization or other entity, whether for-profit or not, exists to realize value for its stakeholders and value is created, preserved, or eroded by management decisions in all activities, from setting strategy to operating the organization day-to-day. ERM supports value creation by conventionally identifying and analyzing risks, thereby enabling management to deal effectively with potential future events that create uncertainty and respond in a manner that reduces the likelihood of downside outcomes while increasing the upside. This is typically done by identification by management of a broad spectrum of risks based on the collective knowledge and data of an organization.

COSO is a set of principle standards for executing ERM.

ERM has issues. For example, it fails to provide a reporting mechanism to senior management. The practical impact is that management is unable to understand the conclusions to be drawn from the ERM analysis and reach appropriate decisions. This results from the failure of ERM to provide a common risk language to be employed by all levels of management across the enterprise to facilitate data analysis and risk identification. While acknowledging the needs for a common risk language, COSO fails to state how to develop this language.

### SUMMARY

These and other needs are addressed by the various aspects, embodiments, and/or configurations of the present disclosure. The present disclosure is directed to a computer architecture to identify, assess, and/or control risk by a profit, nonprofit, or governmental organization, particularly a business enterprise or other entity.

In an embodiment of the disclosure, a method, system, and computer readable medium are provided that:

(a) determine an important set of a plurality of potential risk events for an organization, each member of the important set of potential risk events having no more than a selected probability of occurring but at least a selected significance of impact on the organization;

(b) determine whether a mitigation strategy exists for each member of the important set of the potential risk events,

(c) when a mitigation strategy exists for a selected member of the important potential risk event set, determine a corresponding mitigated significance of impact for the selected member of the important potential risk event set; and

(d) determine a more important set of the plurality of potential risk events, each member of the more important set having at least one of no mitigation strategy and at least a selected mitigated significance of impact on the organization.

The risk module can initially determine a first set of the potential risk events for the organization, each member of the first set of risk events having at least a selected probability of occurring but no more than a selected significance of impact on the organization. A second set of potential risk events excludes members of the first set of potential risk events.

The embodiment can be implemented as an automated framework for identifying and isolating the most important risks from a larger pool of identified important risks (“the most important of the most important”). Like the COSO ERM framework, the framework can define essential components, suggest a common language, and/or provide clear direction and guidance for enterprise risk management but, unlike COSO, the framework can more effectively profile, analyze, classify and filter risks. The framework can avoid entanglement in identifying low, medium, and high levels of risks, which can cause risk confusion and blindness by management and other personnel, thereby resulting in a failure to understand and react to the most critical risks confronted by the organization.

In one configuration, risks are viewed in the context of four categories, namely strategic, operations, reporting and compliance risks and, within each category, an interrelated structure is employed, namely internal environment (which establishes a risk management philosophy), objective setting (to consider risk strategy in the setting of objectives), event identification (to differentiate risks and opportunities and identify those events occurring internally or externally that can affect strategy and achievement), risk assessment (to allow an entity to understand the extent to which potential events might impact objectives and qualitatively and quantitatively characterize risks from the dual perspectives of likelihood and impact), risk response (to identify and evaluate possible responses to risk), control activities (to characterize the policies and procedures that help ensure that the risk responses, and other entity directives, are carried out), information and communication (to identify, capture, and communicate pertinent information in a form and timeframe that enables enterprise management to discharge its responsibilities), and monitoring (to ascertain the effectiveness of the other ERM components, such as by ongoing monitoring of activities and separating evaluations). Management considers activities at all levels of the organization, such as at the enterprise, division or subsidiary, and business unit processes levels.

In an embodiment, for a given risk category the process begins by the event identification, risk assessment, and risk response operations noted above. These stages are implemented initially, by characterizing risk areas that are more likely to happen but can carry less immediate risk per event. The next step is to characterize risk areas that are not likely to happen but if they did would have significant impact to the organization. These two steps effectively identify important risks and filter out the risks of lesser importance. The next step is to remove surviving risks if the risk areas have been previously identified and are currently the subject of related, reliable mitigation plans. The final step characterizes the surviving set of important risks as the most important identified risks requiring immediate further mitigation efforts to be implemented. These steps each require the participation and feedback not only of management but other enterprise personnel deemed to have relevant input. This series of steps effectively provides a universal risk language for management by providing a “storyboard” of risk for upper management and reduces significantly the likelihood of data paralysis and risk confusion frequently experienced with the conventional COSO ERM framework.

The above algorithm(s) can be implemented in a distributed or non-distributed computational framework. The framework can have a database for storing organizational information and various computational modules, including a risk module. The risk module can, with or without human input, identify, for a given risk category the population or set of organization personnel to be involved in the risk analysis effort and in what order or sequence and in which of the steps they are to be involved. The risk module can initially mine the database, such as by keyword or keyword phrase identification, to identify potential risks for the selected category. Alternatively or additionally, the risk module can be an intelligent module, such as a module using artificial intelligence (e.g., fuzzy logic), to monitor, characterize and analyze the conduct of the organization and its component business functions and operations and identify potential risk events for consideration by decision makers. Business thresholds can be set to trigger interrupts for risk mitigation. Communications, such as email, can be forwarded to each identified person, requesting risk event identification and optionally providing potential risk events for consideration. Responses can be collected and provided to an automated and/or human decision maker to filter the identified risk areas to a smaller subset. These steps can be performed iteratively until all of the risks have been assessed.

The risk module can correlate risks across components of the organization or risk categories to identify risk events that COSO would ignore due to its emphasis on a risk category-by-risk category analysis. This can also be used by global organizations to identify risks across multi-cultural lines. For example, the risk module can identify potential business problems and risks associated with business and risk outcomes, compare the risk profiles from different business units, and develop an overall risk strategy for the entire organization. It can consider potential risk events at multiple levels, segments, or parts of an organization, such as at the enterprise-level, affiliate-level (e.g., division and subsidiary), and business unit-level.

The approach can have a variety of applications. For example, the approach can be used not only by an organization on itself but also to analyze target organizations as a sort of due diligence and competitor organizations for the purpose of competing more effectively against them.

The present disclosure can provide a number of other advantages depending on the particular aspect, embodiment, and/or configuration. The disclosure differs from conventional COSO techniques in many ways, including the fact that it filters and how it filters information to identify the most important of the most important risk events requiring mitigation. It further provides a universal risk and risk mitigation language, thereby enabling decision makers to more effectively understand, select, and mitigate risks.

Yet more advantages will be apparent from the disclosure.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The terms “determine”, “calculate” and “compute,” and variations thereof, as used herein, are used interchangeably and include any type of methodology, process, mathematical operation or technique.

The term “internet search engine” refers to a web search engine designed to search for information on the World Wide Web and FTP servers. The search results are generally presented in a list of results often referred to as SERPS, or “search engine results pages”. The information may consist of web pages, images, information and other types of files. Some search engines also mine data available in databases or open directories. Web search engines work by storing information about many web pages, which they retrieve from the html itself. These pages are retrieved by a Web crawler (sometimes also known as a spider)—an automated Web browser which follows every link on the site. The contents of each page are then analyzed to determine how it should be indexed (for example, words are extracted from the titles, headings, or special fields called meta tags). Data about web pages are stored in an index database for use in later queries. Some search engines, such as Google™, store all or part of the source page (referred to as a cache) as well as information about the web pages, whereas others, such as AltaVista™, store every word of every page they find.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The term “metadata” is normally described as “data about data”. Structural metadata means the specification of data structures. The actual data content is commonly unknown when the data structures or containers are being designed. Descriptive metadata, on the other hand, is about individual instances of application data or the data content.

The term “module” as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that an individual aspect of the disclosure can be separately claimed.

The terms “online community”, “e-community”, or “virtual community” mean a group of people that primarily interact via a computer network, rather than face to face, for social, professional, educational or other purposes. The interaction can use a variety of media formats, including wilds, blogs, chat rooms, Internet forums, instant messaging, email, and other forms of electronic media. Many media formats are used in social software separately or in combination, including text-based chatrooms and forums that use voice, video text or avatars.

The term “tag” is a non-hierarchical keyword or term assigned to a piece of information (such as digital image, or computer file).

The term “tag cloud” or “word cloud” or “weighted list” is a visual representation for text data, typically used to depict keyword metadata (tags), such as to visualize free form text. “Tags” are usually single words, and the importance of each tag is shown with font size or color. This format is useful for quickly perceiving the most prominent terms and for locating a term alphabetically to determine its relative prominence. The tags can be hyperlinked to items associated with the tag.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

FIG. 1 is a block diagram of a risk management system according to an embodiment;

FIG. 2 is a block diagram of a risk module according to an embodiment;

FIG. 3 is a flow chart according to an embodiment;

FIG. 4 is a flow chart according to an embodiment;

FIGS. 5A-B are flow charts according to an embodiment;

FIG. 6 is a graphical representation of a risk identification and assessment process according to an embodiment; and

FIG. 7 is a graphical representation of a risk identification and assessment process according to an embodiment.

### DETAILED DESCRIPTION

The invention will be illustrated below in conjunction with an exemplary communication system. Although well suited for use with a distributed processing network, the invention is not limited to use with any particular type of network or configuration of system elements. Those skilled in the art will recognize that the disclosed techniques may be used in any computational system in which risk assessment is performed.

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

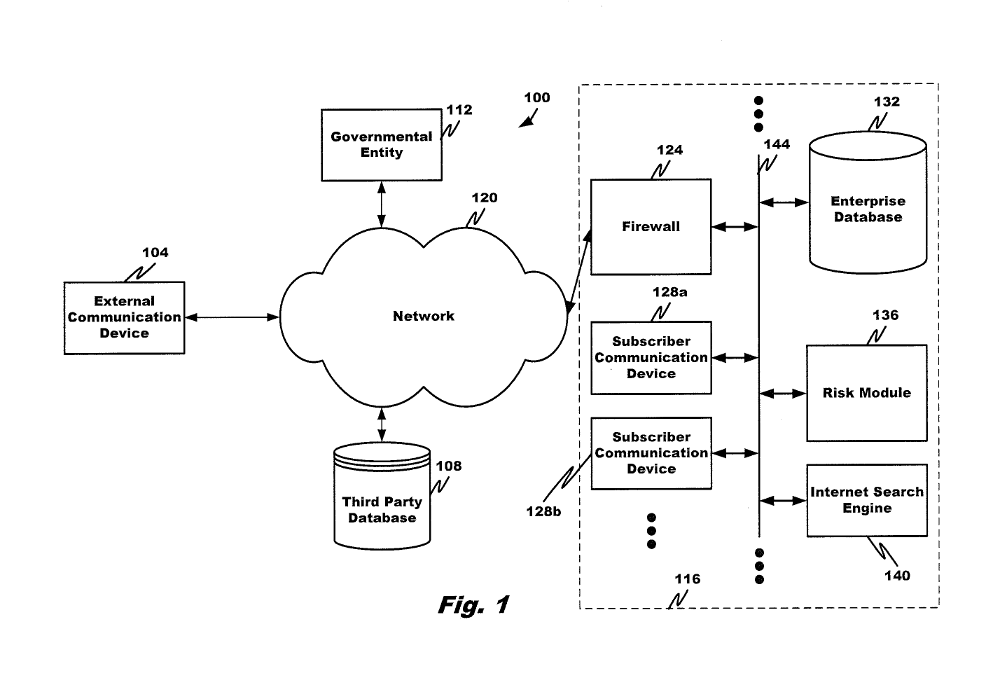

With reference to FIG. 1, a risk management system 100 includes one or more external communication devices 104, a (federated) third party database 108, a governmental entity 112, and an enterprise network 116, all interconnected by a network 120.

The external communication device(s) 104 may comprise any type of known communication equipment or collection of communication equipment. Examples of a suitable communication device 108a-n include, but are not limited to, a personal computer, laptop, Personal Digital Assistant (PDA), cellular phone, smart phone, telephone, or combinations thereof. The communication device(s) may be associated with an employee, consultant, or other party related to the enterprise.

The third party database 108 can be any database maintained by a third party providing information of interest to risk assessment, such as a news source, a stock brokerage service, an investment analysis firm, a consulting firm, an online community, and web site, to name but a few.

The governmental entity 112 can be any governmental entity electronically providing governmental information of interest to risk assessment. Governmental information includes historic, existing, or proposed statutes, regulations, rulings, investigations, policy statements, and the like. Examples include a regulatory agency, law enforcement authority, security or exchange agency, legislative body, and the like. Such governmental information, for instance, can be important to evaluating regulatory and other compliance risk events confronting the enterprise.

The enterprise network 116 includes a number of components, including a firewall 124, a plurality of subscriber communication devices 128a, b . . . , an enterprise database 132, an internet search engine 140, and a risk module 136, interconnected by internal network 144.

The firewall 124 can be any device or set of devices designed to permit or deny network transmissions based upon a set of rules to protect networks from unauthorized access while permitting legitimate communications to pass.

The subscriber communication devices 128a, b, . . . , can be any of the communication devices discussed above.

The enterprise database 132 contains information related to the enterprise and its operations. The database 132 includes, for example, information regarding enterprise finances, technology, operations, employees, accounts receivable and payable, affiliated entities (e.g., corporate entities), tax liability and returns, liabilities, and the like.

The internet search engine 140 can be any internet search engine.

The communication networks 120 and 144 can be a trusted or untrusted network. In accordance with at least some embodiments, the network 120 may comprise any type of known communication medium or collection of communication media and may use any type of protocols to transport messages. The communication network(s) 120 and 144 may include wired and/or wireless communication technologies. The Internet is an example of the communication network(s) 120 and 144 that constitutes an Internet Protocol (IP) network consisting of many computers, computing networks, and other communication devices located all over the world, which are connected through many telephone systems and other means. Other examples of the networks 120 and 144 include, without limitation, a Local Area Network (LAN), a Wide Area Network (WAN), a Regional Area Network (RAN), a Metropolitan Area Network (MAN), a cellular network, and any other type of packet-switched or circuit-switched network known in the art. In addition, it can be appreciated that the network(s) 120 and 144 need not be limited to any one network type, and instead may be comprised of a number of different networks and/or network types.

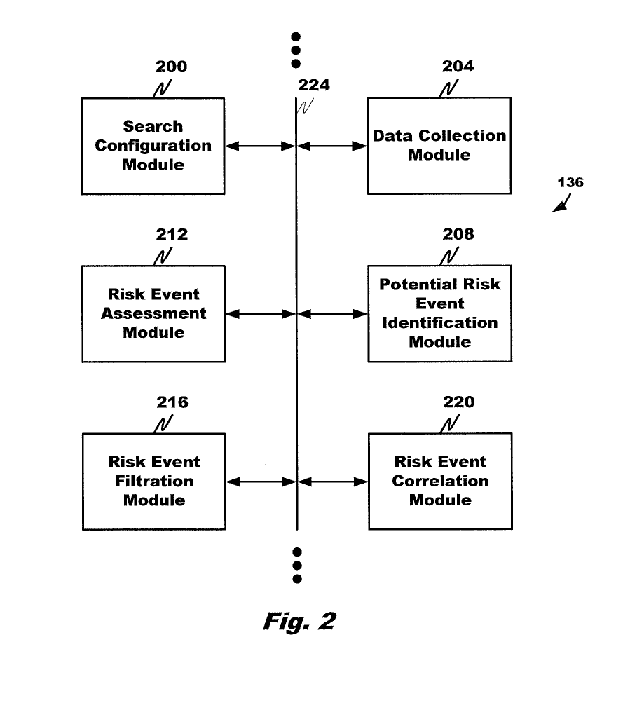

The risk module 136, for each risk category, administers a risk management philosophy, sets risk objectives, identifies and assesses potential risk events, recommends potential risk responses and control activities, communicates the foregoing information to decision makers, and/or monitors instances and/or probabilities of risk events. With reference to FIG. 2, the risk module 136 includes various sub-components for performing these operations. The subcomponents include a search configuration module 200, a data collection module 204, a risk event assessment module 212, a potential risk event identification module 208, a risk event filtration module 216, and a risk event correlation module 220, all interconnected by a communications infrastructure 224 (which can be a bus, network, or other communication medium).

The search configuration module 200 formulates a search strategy for each risk category and/or business unit. The search strategy identifies not only the type of search or search structure but also the sources to be searched. In a simple case, the search strategy includes one or more keywords or keyphrases, which may be received from enterprise management and/or formulated based on a set of policies, objectives, rules, risk philosophy, organizational risk culture, organization integrity and ethical values, and the like. Exemplary objectives include “to be the first or second largest, full-service health care provider in mid-size metropolitan markets” and “to initiate dialog with leadership of 10 top underperforming hospitals and negotiate agreements with two hospitals this year”. Objectives can be a function of an organization's mission statement (which for the prior examples might be “to provide high-quality accessible and affordable community-based health care). The keywords or keyphrases may be based on a frequency of occurrence of the keyword or keyphrase in a selected type and/or source of information. In a more complex case, the search strategy includes, in addition or alternatively to keywords or keyphrases, one or more metrics, such as performance thresholds, statistics, predictions, or projections. The metrics may be historical, current, and/or projected (such as based on a mathematical algorithm).

The data collection module 204 conducts the search strategy received from the search configuration module 200 and outputs metadata for further analysis by the potential risk identification module 208. The metadata can be of many forms, including tag or word cloud. The tag can link to a source of the information, a corresponding policy, objective, or rule, or body of information from which the word is extracted.

The potential risk event identification module 208 analyzes the metadata received from the data collection module 204 and identifies potential risk events (or areas) for further analysis. The potential risk event, in one embodiment, is represented by a container or profile linked to tags or words in the tag or word cloud. In one configuration, the potential risk event identification module 208 determines a probability of occurrence of each potential risk event. This can be done, for example, based on a frequency of occurrence of a key word or phrase in the tag or word cloud, a proximity of a metric to a selected threshold, a mathematical projection or prediction of a metric as a function of time or other enterprise performance variable, and the like. Probability can be expressed mathematically as a value and/or as a set of relationships, such as by a probability axiom probability theory, Cox's theorem, measure theory, law of total probability, borel algebra, sigma-algebra, set theory, independent probability, mutually exclusive or not mutually exclusive probability, and/or conditional probability.

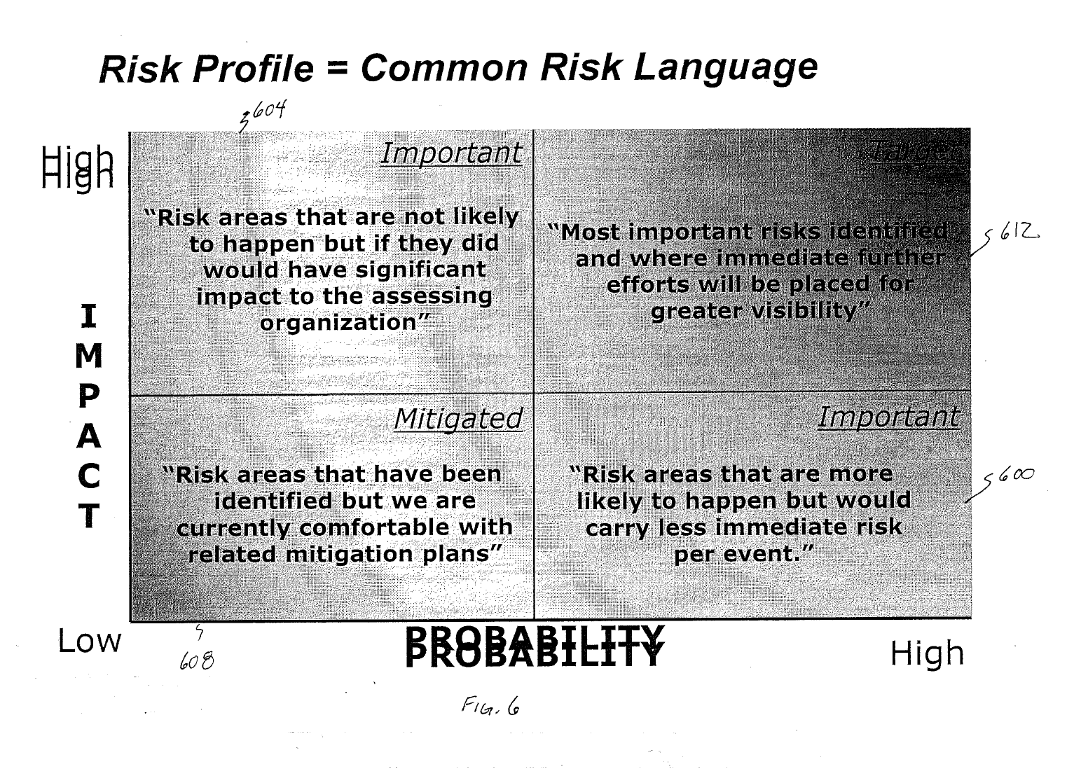

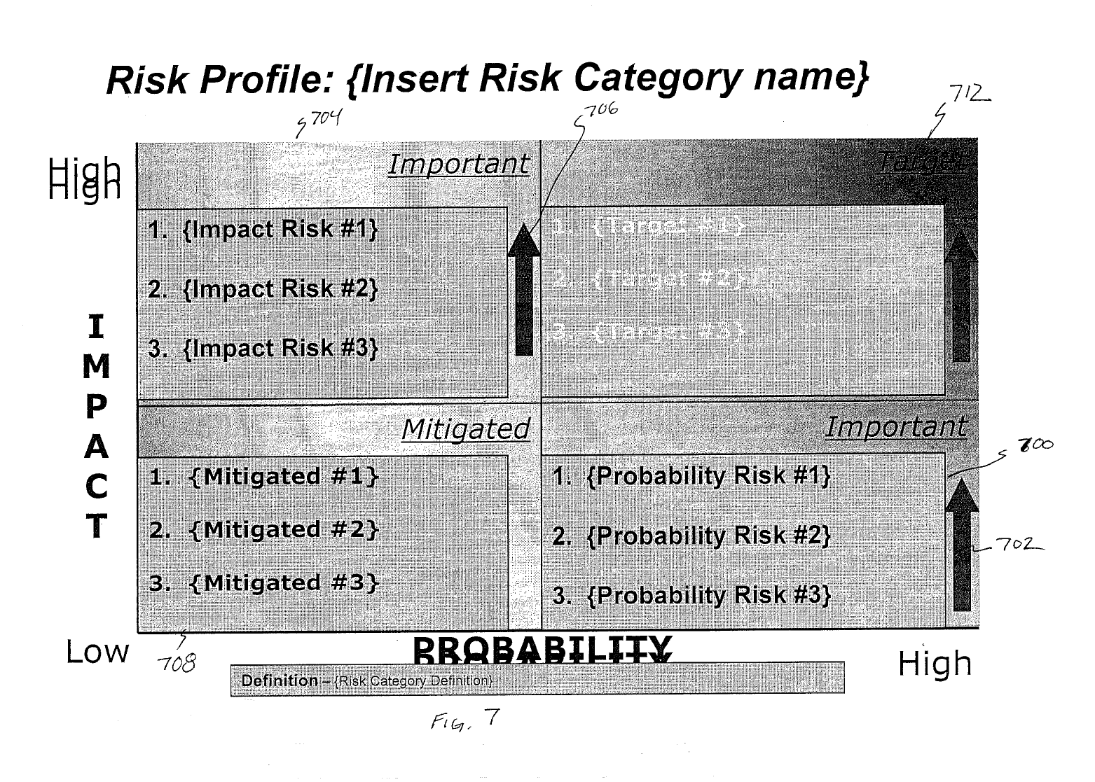

The risk event assessment module 212 characterizes potential risk events that are more likely to happen but would carry less immediate risk per event and potential risk events that are not likely to happen but if they did would have a significant impact on the enterprise and/or its operations. The significance of impact can be determined by any suitable method and expressed in any suitable metric. In one configuration, the significance of impact is determined based on disruption in profit levels, such as by an increase in capital and/or operating costs and/or decrease in sales, and expressed in terms of a selected currency (which for global operations may be normalized to a selected country's currency). These operations are shown in FIGS. 6 and 7 (which plot impact of the potential event (vertical axis) against probability of the potential event occurring (horizontal axis) in boxes 600 and 700 for the former and 604 and 704 for the latter. In other words, boxes 600 and 700 rank the potential risk events of less than a selected level of impact in order of probability of occurrence (from lowest probability to highest probability as shown by the arrow 702) while boxes 604 and 704 rank the potential risk events having a level of impact of greater than the selected level of impact in order of level or significance of impact (from lowest level of impact to highest as shown by arrow 706).

In boxes 608 and 708, the risk event assessment module 212, for each potential risk event having a significant impact on the enterprise, determines whether one or more corresponding (possible) mitigation strategies exist to reduce a level of significance of the impact, if appropriate quantifies a mitigated level of impact for each mitigation strategy, and ranks the (mitigated) potential risk events in order of mitigated significance of impact (from lowest to highest mitigated impact). The mitigation strategies and/or their respective impact on the level of significance of the corresponding potential risk event may be received from enterprise management, determined by rules and/or policies, quantified by a suitable mathematical algorithm, determined by historic enterprise or other data, and the like. The mitigated level of impact for a selected potential risk event is based on the maximum level of mitigation produced by the various mitigation strategies applicable to the selected potential risk event. The potential risk events having less than a selected threshold of significance of their respective mitigated significance of impact are identified as risk areas that have been identified but the enterprise is currently comfortable with related mitigation plans.

The risk event filtration module 216, in boxes 612 and 712, identifies those potential risk events not having satisfactory or acceptable mitigation strategies as the most important risks requiring immediate further attention or mitigation efforts. If no mitigation strategy is applicable to a potential risk event having a significant impact on the enterprise or the mitigated significance of impact is greater than a selected level of significance, the risk event filtration module 216 identifies the potential risk event as a target risk event in box 712.

The risk event correlation module 220 correlates a selected risk events or set of risk events across multiple business units to identify other business units requiring further attention or mitigation efforts. In one configuration, the correlated risk events are the target risk events in box 712 of FIG. 7. The correlation operation can be as simple as comparing the target risk events for selected business units to identify common target risks.

The operations of the various modules will now be discussed.

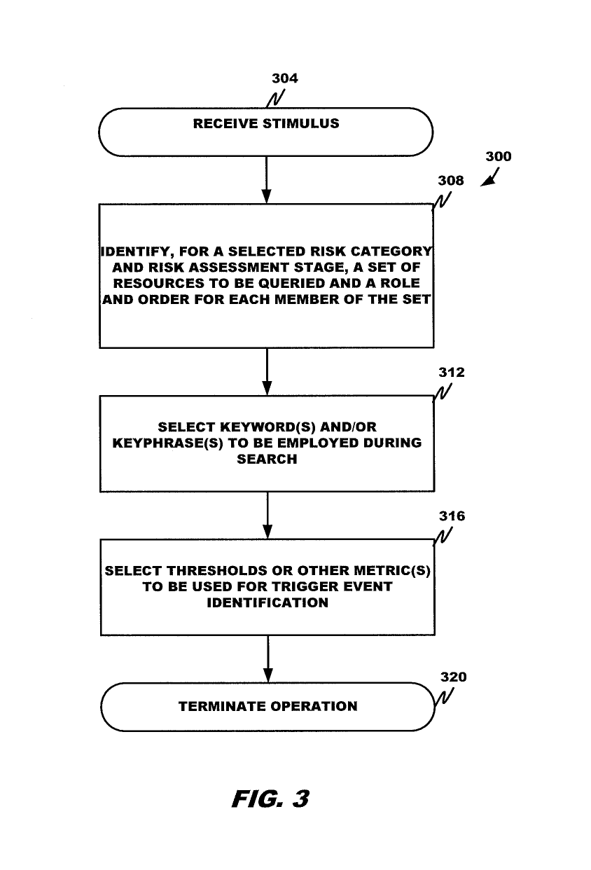

Referring to FIG. 3, a process flow 300 for the search configuration module 200 is depicted.

In step 304, the search configuration module 200 receives a stimulus. The stimulus may be a request from an administrator, manager, or other user, an interrupt due to occurrence of a trigger event, and the like. The trigger event, for example, may be occurrence or a likelihood of occurrence of a selected risk event, a metric or statistic approaching or surpassing or falling below a selected threshold, receipt of a set of “seed” potential risk events from the organization, and the like.

In steps 308 and 312, the search configuration module 200 identifies, for a selected risk category and/or potential risk event assessment stage and/or for a selected possible risk event, a search strategy, such as a set of resources to be queried (e.g., human resources such as management, board of directors, risk officers, consultants, auditors, managers, staff, and the like and/or non-human automated resources such as a database), a role and order of query for each member of a set of resources, and a step or stage of risk identification and assessment in which they are to be queried. The search strategy can have differing one or more differing search criterion for different (human or non-human) resources, one or more conditions for a selected resource to be searched, what search queries are to be provided to each identified resource, and an order or sequence or step or stage of search for the various resources. The search criteria commonly are selected keyword(s) and/or keyphrase(s) to be employed during the search and/or questions related to the selected risk category.

In step 316, the search configuration module 200 selects threshold(s) or other metric(s) to be used for trigger event identification. Such selected threshold(s) or metric(s) are used as contingencies for conditional searches. In other words, the search is not conducted until the contingency or contingencies occur.

In step 320, the search configuration module 200 terminates operation.

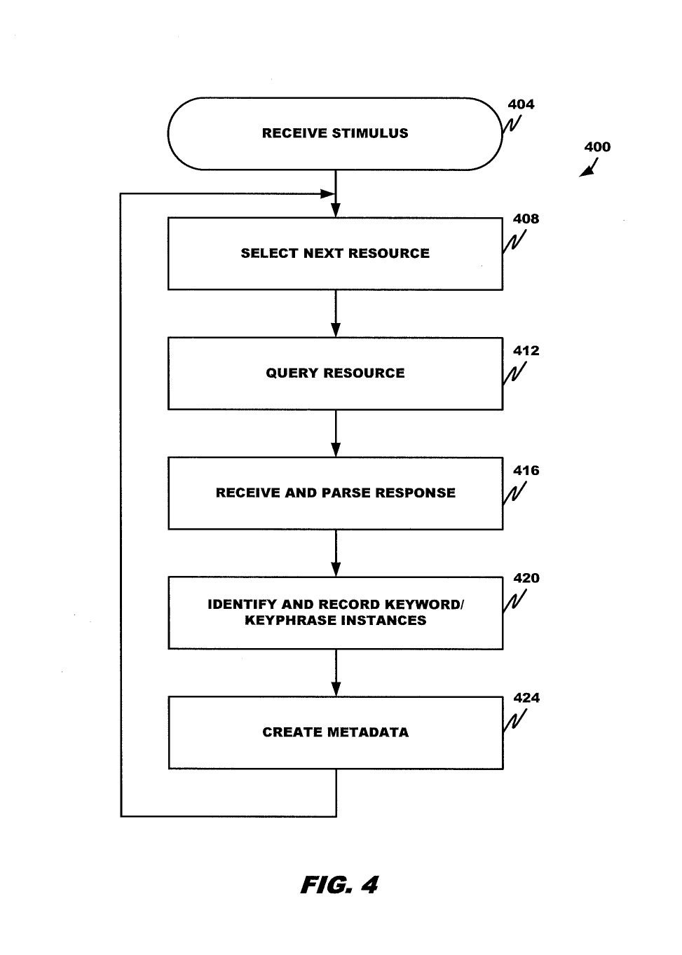

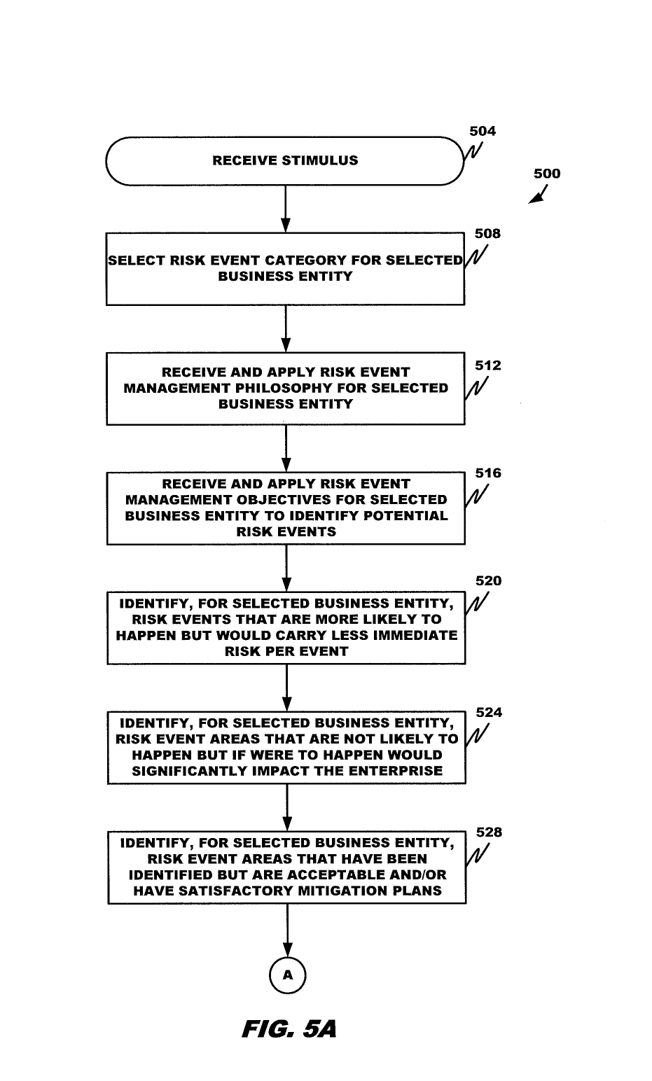

Referring to FIG. 4, a process flow 400 for the data collection module 204 is depicted.

In step 404, the data collection module 204 receives a stimulus. The stimulus may be a request from an administrator, manager, or other user, an interrupt due to occurrence of a trigger event, and the like. The trigger event, for example, may be occurrence or a likelihood of occurrence of a selected risk event, a metric or statistic approaching or surpassing or falling below a selected threshold, an interrupt received from another risk module component, and the like.

In step 408, the data collection module 204 performs or implements the search strategy received from the search configuration module 200, which typically requires the data collection module 204 to select a next resource to be queried or searched and, in step 412, query the selected resource. The resource, for example, can be an employee or other enterprise representative, such as via subscriber communication device 128 or external communication device 104, the enterprise database 132, and/or a governmental entity 112 or third party database 108, via Internet search engine 140. By way of illustration, an interactive web interface can be provided to an organizational representative, such as a manager, to collect responses to selected questions related to the selected risk category and/or business unit of which the manager is a part. Typically, the questions are related to the top potential risk events of the manager, the possible impact of the risk events on the organization, and how those risk events could be mitigated. In effect, the web interface conducts an automated interview of the manager. The interview may be a complete-the-blank and/or yes/no question format. The former approach has the benefit of placing fewer constraints on the manager's response(s) while the latter approach has the benefit of using a more universal risk event expression language for upper management. Keyword or keyphrase spotting can be applied to the various interview responses received from the selected organizational representatives. In other configurations, other communication modalities can be employed, such as email, surveys (in which a resource is contacted by a human or non-human resource and questioned, with the responses being recorded in a suitable manner), manual completion of a physical or electronic form, and the like.

In steps 416 and 420, the data collection module 204 receives, parses, compiles, interprets, and/or translates the response. Parsing can be done using selected keywords or keyphrases and the instances of the keywords or keyphrases identified and recorded.

In step 424, the data collection module 204, creates metadata for further analysis.

The data collection module 204 then loops back to step 408 for a next selected resource.

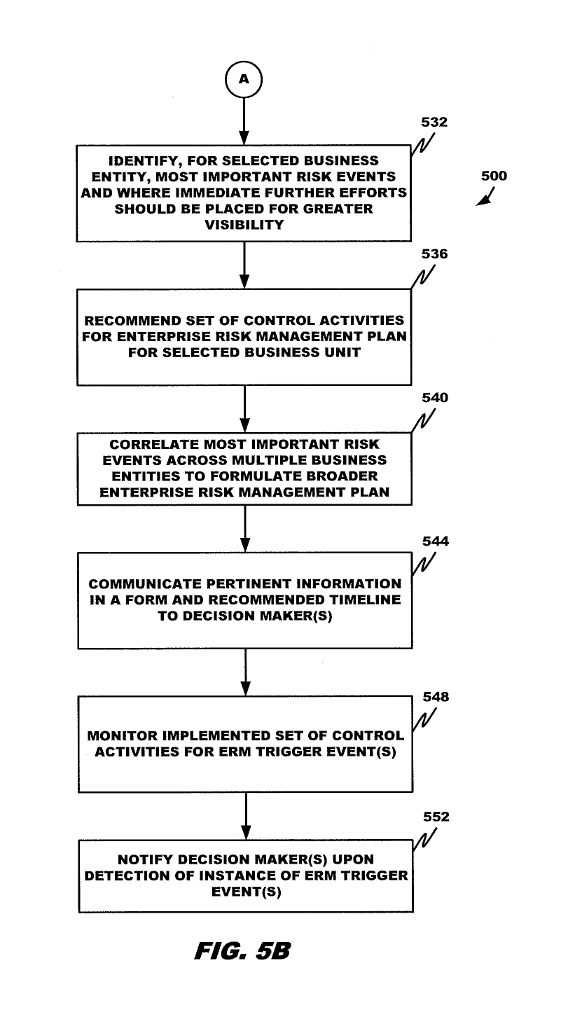

Referring to FIG. 5, a process flow 500 for the remaining sub-components of the risk module 140 is depicted.

In step 504, potential risk event identification, risk event assessment, risk event filtration, and risk event correlation modules 208, 212, 216, and 220 receive a stimulus. The stimulus may be a request from an administrator, manager, or other user, an interrupt due to occurrence of an ERM trigger event (discussed below), and the like.

In step 508, the potential risk event identification module 208 selects a risk event category for a selected business unit or entity. In one example, risks are viewed in the context of four categories, namely strategic, operations, reporting and compliance risks.

In step 512, the potential risk event identification module 208 receives and applies the risk event management philosophy for the selected business unit. This step is often referred to as internal environment.

In step 516, the potential risk event identification module 208 receives and applies risk event management objectives for the selected business unit to identify potential risk events. Steps 512 and 516 consider the risk strategy (philosophy) in the setting of objectives, uses the objectives to differentiate risks and opportunities, and identifies those events occurring internally or externally that can affect strategy and achievement.

In steps 520 and 524, the risk event assessment module 212 identifies, for the selected business unit, risk events that are more likely to happen but would carry less immediate risk per event and risk events that are not likely to happen but if they were to happen would impact significantly impact the enterprise. Risk assessment allows an entity to understand the extent to which potential events might impact objectives and qualitatively and quantitatively characterize risks from the dual perspectives of likelihood and impact.

In step 528, the risk event assessment module 212 identifies, for the selected business unit, risk events that have been identified but are acceptable and/or have satisfactory mitigation plans. The risk event assessment module 212 identifies and evaluates possible responses to risk.

In step 532, the risk event filtration module 216 identifies, for a selected business unit, the most important risk events and where immediate further efforts should be placed for greater visibility.

In step 536, the risk module 136 recommends a set of control activities for the enterprise risk management plan for the selected business unit. The control activities characterize the policies and procedures that help ensure that the risk responses and other entity directives are carried out.

In step 540, the risk event correlation module 220 correlates the most important risk events across multiple business units and/or multiple geographically dislocated parts of a selected business unit to formulate a broader enterprise risk management plan. In the latter case, differing cultures can produce different potential risk event characterizations. In this event, a separate correlation step may be performed before step 532.

In step 544, the risk module 136 communicates the pertinent information in a form and recommended timeline to decision maker(s). This step identifies, captures, and communicates, by a suitable communication medium, pertinent information in a form and timeframe that enables people to carry out their responsibilities.

In step 548, the risk module 136 monitors the implemented set of control activities for ERM trigger events. ERM trigger events can be the same or different from trigger events formulated by the search configuration module 200. Example ERM trigger events include an occurrence or a likelihood of occurrence of a selected risk event, selected metric or statistic rising above or falling below one or more selected threshold(s) or other metric(s), detection of a set of keywords or keyphrases in one or more communications or communication types, detection of a threshold frequency of a set of keywords or keyphrases in one or more communications or communication types, receipt of a command from a user, and comparison of an operational state to a selected template. In this step, the risk module 136 identifies when the probability of occurrence of a selected potential risk event increases and therefore ascertains the effectiveness of the other ERM components by ongoing monitoring of activities and separate evaluations.

In step 552, the risk module 136 notifies decision makers upon detection of an instance of an ERM trigger event.

A number of variations and modifications of the disclosure can be used. It would be possible to provide for some features of the disclosure without providing others.

For example in one alternative embodiment, the risk module is an intelligent module, such as a module using artificial intelligence (e.g., fuzzy logic), to monitor, characterize and analyze the conduct of the organization and its component business functions and operations and identify potential risk events for consideration by decision makers.

In another alternative embodiment, the approach is used to analyze a target organization, other than the enterprise, as a sort of due diligence and/or competitor organizations for the purpose of competing more effectively against them.

In some embodiments, the search strategy developed by the search configuration module 200 is not limited to an initial stage of potential risk event identification but is involved in multiple steps or stages of potential risk event identification and assessment. In other words, the data collection module 204 collects information in multiple steps or stages of the above-described process. Separate search strategies can be applied to different stages and the search configuration module 200 may formulate dynamically a search strategy step-by-step or stage-by-stage based on data collected by the data collection module 204 in one or more prior steps or stages. By way of illustration, the search configuration module 200 may, after completion of one or more of boxes 600 and 700, 604 and 704, 608 and 708, and 612 and 712, formulate a search strategy to be performed by the data collection module 204 before the next set of boxes are performed.

In other embodiments, one or more of the steps can be performed manually.

In other embodiments, the risk module is used to identify and analyze potential risk events that positively impact the organization. For example, the risk module can be used to identify the potential risk events having the greatest positive impact to the organization, such as increases in gross revenue and/or profit. While the above discussion has been focused on potential risk events adversely impacting the organization, the disclosure is not to be limited to this type of negative risk. Rather, risk is broadly understood to be any event that impacts, positively or negatively, an organization.

In another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The exemplary systems and methods of this disclosure have been described in relation to computational systems. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
determining, by a microprocessor executable risk module, an important set of a plurality of potential risk events for an organization, each member of the important set of potential risk events having no more than a selected probability of occurring but at least a selected significance of impact on the organization;
determining, by the microprocessor executable risk module, whether a mitigation strategy exists for each member of the important set of the plurality of potential risk events and, when a mitigation strategy exists for a selected member of the important set, determining a corresponding mitigated significance of impact for the selected member of the important set of the plurality of potential risk events; and
determining, by the microprocessor executable risk module, a more important set of the plurality of potential risk events, each member of the more important set having at least one of no mitigation strategy and at least a selected mitigated significance of impact on the organization.

2. The method of claim 1, further comprising:
determining, by the microprocessor executable risk module, a first set of the plurality of potential risk events for the organization, each member of the first set of risk events having at least a selected probability of occurring but no more than a selected significance of impact on the organization to form a second set of potential risk events, the second set of potential risk events being the plurality of potential risk events excluding members of the first set of the plurality of potential risk events.

3. The method of claim 2, wherein the important set of the plurality of potential risk events is derived from the second set of potential risk events.

4. The method of claim 3, further comprising:
identifying, by the microprocessor executable risk module, the plurality of potential risk events by formulating a search strategy for a selected risk category and/or business segment and implementing the search strategy to collect data from a plurality of human and non-human resources and produce metadata for further analysis.

5. The method of claim 4, wherein the metadata is in the form of a tag cloud comprising tags linking to a data source.

6. The method of claim 4, wherein a non-human resource is a server maintained by a governmental entity.

7. The method of claim 4, wherein each of the plurality of potential risk events has a corresponding probability of occurrence.

8. The method of claim 4, wherein the determining steps are performed independently for multiple parts of the organization and further comprising:
correlating multiple sets of identified potential risk events among the multiple parts of the organization.

9. A system, comprising:
a microprocessor executable risk module operable to determine:
an important set of a plurality of potential risk events for an organization, each member of the important set of potential risk events having no more than a selected probability of occurring but at least a selected significance of impact on the organization;
whether a mitigation strategy exists for each member of the important set of the plurality of potential risk events;
when a mitigation strategy exists for a selected member of the important set, a corresponding mitigated significance of impact for the selected member of the important set of the plurality of potential risk events; and
a more important set of the plurality of potential risk events, each member of the more important set having at least one of no mitigation strategy and at least a selected mitigated significance of impact on the organization.

10. The system of claim 9, wherein the risk module is further operable to:
determine a first set of the plurality of potential risk events for the organization, each member of the first set of risk events having at least a selected probability of occurring but no more than a selected significance of impact on the organization to form a second set of potential risk events, the second set of potential risk events being the plurality of potential risk events excluding members of the first set of the plurality of potential risk events.

11. The system of claim 10, wherein the important set of the plurality of potential risk events is derived from the second set of potential risk events.

12. The system of claim 11, wherein the risk module is further operable to identify the plurality of potential risk events by formulating a search strategy for a selected risk category and/or business segment and implementing the search strategy to collect data from a plurality of human and non-human resources and produce metadata for further analysis.

13. The system of claim 12, wherein the metadata is in the form of a tag cloud comprising tags linking to a data source.

14. The system of claim 12, wherein a non-human resource is a server maintained by a governmental entity.

15. The system of claim 12, wherein each of the plurality of potential risk events has a corresponding probability of occurrence.

16. The system of claim 12, wherein the determining operations are performed independently for multiple parts of the organization and wherein the risk module is further operable to correlate multiple sets of identified potential risk events among the multiple parts of the organization.

17. A non-transient computer readable medium comprising microprocessor-executable instructions for performing steps comprising:
determining, by a microprocessor executable risk module, an important set of a plurality of potential risk events for an organization, each member of the important set of potential risk events having no more than a selected probability of occurring but at least a selected significance of impact on the organization;
determining, by the microprocessor executable risk module, whether a mitigation strategy exists for each member of the important set of the plurality of potential risk events and, when a mitigation strategy exists for a selected member of the important set, determining a corresponding mitigated significance of impact for the selected member of the important set of the plurality of potential risk events; and
determining, by the microprocessor executable risk module, a more important set of the plurality of potential risk events, each member of the more important set having at least one of no mitigation strategy and at least a selected mitigated significance of impact on the organization.

18. The computer readable medium of claim 18, further comprising instructions to perforin an additional step comprising:
determining, by the microprocessor executable risk module, a first set of the plurality of potential risk events for the organization, each member of the first set of risk events having at least a selected probability of occurring but no more than a selected significance of impact on the organization to form a second set of potential risk events, the second set of potential risk events being the plurality of potential risk events excluding members of the first set of the plurality of potential risk events.

19. The computer readable medium of claim 18, wherein the important set of the plurality of potential risk events is derived from the second set of potential risk events.

20. The computer readable medium of claim 19, further comprising instructions to perform an additional step comprising:
identifying, by the microprocessor executable risk module, the plurality of potential risk events by formulating a search strategy for a selected risk category and/or business segment and implementing the search strategy to collect data from a plurality of human and non-human resources and produce metadata for further analysis.

21. The computer readable medium of claim 19, wherein the metadata is in the form of a tag cloud comprising tags linking to a data source.

22. The computer readable medium of claim 19, wherein a non-human resource is a server maintained by a governmental entity.

23. The computer readable medium of claim 19, wherein each of the plurality of potential risk events has a corresponding probability of occurrence.

24. The computer readable medium of claim 19, wherein the determining steps are performed independently for multiple parts of the organization and further comprising instructions to perform an additional step comprising:
correlating multiple sets of identified potential risk events among the multiple parts of the organization.
